(19) United States
(12) Patent Application Publication
(10) Pub. No.: US 2026/0048974 A1
(43) Pub. Date: Feb. 19, 2026

(54) DEXTERITY TOOL FOR OPENING CONTACT LENS PACKAGE

(71) Applicant: Johnson & Johnson Vision Care, Inc., Jacksonville, FL (US)

(72) Inventors: Scott F. Ansell, Ponte Vedra Beach, FL (US); Ryan Sherrill, Jacksonville Beach, FL (US); Julie Link, Ponte Vedra Beach, FL (US)

(21) Appl. No.: 18/808,171

(22) Filed: Aug. 19, 2024

(51) Int. Cl. B67B 7/00; A45C 11/00

(52) U.S. Cl. CPC B67B 7/00; A45C 11/005

(57) ABSTRACT

Provided herein are several embodiments of a dexterity tool for opening a contact lens package to remove a contact lens inside. Some embodiments may have a housing which clamps down on the contact lens package to aid in the removal of the lid from the contact lens package. Some embodiments may also have a top clamshell housing with a movable jaw connected to the top clamshell housing and an opening in the top clamshell housing. Some embodiments may also include a bottom clamshell housing hingedly attached to the top clamshell housing so that the top housing hinges about a hinge axis relative to the bottom housing and further contains a bowl positioned within the bottom clamshell housing and a platform surrounding the bowl. A fixed jaw may be connected to the platform such that when the tool is placed in a closed position the contact lens package is sandwiched in between the movable jaw and the fixed jaw.

### BACKGROUND

Packaging designs for contact lenses have continued to decrease in overall size in an effort to save on packaging materials. A reduction in plastics, adhesives, and solution can result in significant savings per package as well as reduce plastics use and has resulted in modern contact lens packages which may be smaller and somewhat more difficult to open than previous designs. For many contact lens patients this is not an issue but for some patients with reduced hand dexterity or strength it can be difficult to open modern contact lens packaging, especially when also suffering from blurry vision, hyperopia, astigmatism, myopia, or similar vision conditions.

### SUMMARY

Provided herein are several embodiments of a dexterity tool for opening a contact lens package to remove a contact lens inside. The tool may have a top clamshell housing with a movable jaw connected to the top clamshell housing and an opening in the top clamshell housing. The tool may also include a bottom clamshell housing hingedly attached to the top clamshell housing so that the top housing hinges about a hinge axis relative to the bottom housing and further contains a bowl positioned within the bottom clamshell housing and a platform surrounding the bowl. A fixed jaw may be connected to the platform such that when the tool is placed in a closed position the contact lens package is sandwiched in between the movable jaw and the fixed jaw.

Some of the embodiments herein provide a dexterity tool for removing the lid of a contact lens package, where the tool has a housing which clamps down on the contact lens package to aid in the removal of the lid from the contact lens package. The housing may also have a top clamshell housing hingedly attached to a bottom clamshell housing. The tool embodiments may have a movable jaw positioned on the top clamshell housing and a fixed jaw positioned on the bottom clamshell housing. In some embodiments the movable jaw is an arch. Some embodiments may also provide an opening in the top clamshell housing which allows access to the lid while the tool is in a closed position. Some embodiments may also provide a bowl positioned within the bottom clamshell housing and a platform surrounding the bowl. In some embodiments a proximal portion of the top housing is flat and a distal portion of the top housing is rounded.

Some embodiments provide a dexterity tool for removing the lid of a contact lens package, the tool having a movable jaw which moves towards a fixed jaw to clamp the contact lens package between the movable jaw and fixed jaw during removal of the lid. In some embodiments the movable jaw extends from a top clamshell housing. In some embodiments the fixed jaw is positioned on a bottom clamshell housing. In some embodiments a bottom clamshell housing is hingedly attached to the top clamshell housing. In some embodiments a user can grasp the lid of the contact lens package while the contact lens package is clamped between the movable jaw and fixed jaw. In some embodiments the lid is uncovered by the top clamshell housing when the tool is closed. In some embodiments when the tool is placed in a closed position the user has more control over the contact lens package while removing the lid.

Also provided herein is a method for using a dexterity tool to open a contact lens package, the method having the steps of opening the dexterity tool, positioning the contact lens package within the tool, closing the dexterity tool, holding the dexterity tool in a closed position while removing a portion of a lid of the contact lens package. The method may also have the step of positioning the contact lens package within the tool which comprises aligning a bowl in the contact lens package with a bowl in the dexterity tool. The method may also have the step of aligning a tab extending from the contact lens package with an aperture placed in the dexterity tool. The method may also have the step of reaching through an opening in the dexterity tool to grasp a tail of the lid on the contact lens package. The method may also have the step of holding the dexterity tool in a closed position is performed with a first hand while the step of removing a portion of a lid of the contact lens package is performed with a second hand.

Some embodiments provide a dexterity tool for opening a contact lens package to remove a contact lens inside, the tool having a top clamshell housing having a movable jaw connected to the top clamshell housing, and an opening in the top clamshell housing. Some embodiments also provide a bottom clamshell housing hingedly attached to the top clamshell housing so that the top housing hinges about a hinge axis relative to the bottom clamshell housing, the bottom clamshell housing comprising with a bowl positioned within the bottom clamshell housing, a platform surrounding the bowl, and a fixed jaw connected to the platform such that when the tool is placed in a closed position the contact lens package is sandwiched in between the movable jaw and the fixed jaw.

Some embodiments also provide where the opening comprises a proximal width located at a proximal end of the top clamshell housing, and a distal width located at a distal end of the top clamshell housing. Some embodiments also provide where the distal width is larger than the proximal width. Some embodiments also provide where the movable jaw is an arch. Some embodiments also provide an aperture sized to accept a portion of the contact lens package. Some embodiments also provide that the aperture comprises one or more holes within the platform. Some embodiments also provide that the aperture is placed between the bowl and the hinge axis. Some embodiments also provide where a proximal portion of the top housing is flat and a distal portion of the top housing is rounded.

Some embodiments provide a dexterity tool for opening a contact lens package having a bowl, a deck, and a tab extending from the deck; the tool having a top clamshell housing with a movable jaw connected to a proximate end of the top clamshell housing and an opening in the top clamshell housing. The tool may also provide a bottom clamshell housing with a bowl positioned within the bottom clamshell housing, a platform surrounding the bowl, an aperture in the platform sized to accept the tab, and a fixed jaw connected to the platform and surrounding the aperture, and a hinge connecting the top clamshell housing with the bottom clamshell housing.

Some embodiments also provide where the movable jaw extends from a proximate edge of the opening in the top clamshell housing. Some embodiments also provide where the tool has a clamping portion that is proximate to the hinge and a clearance portion that is distal to the hinge. Some embodiments also provide where the bowl of the bottom clamshell housing is sized to accept the bowl of the contact lens package. Some embodiments also provide where the top clamshell housing has an elliptical shape. Some embodiments also provide where the opening is aligned with the bowl of the package and the bowl of the bottom housing when the device is in a closed position. Some embodiments also provide where when the tool is placed in a closed position the deck of the contact lens package is sandwiched in between the movable jaw and the fixed jaw.

Also provided herein is a method for using a dexterity tool to open a contact lens package to remove a contact lens, the method having the steps of opening the dexterity tool, aligning a bowl in the contact lens package with a bowl in the dexterity tool, closing the dexterity tool until there is enough clamping pressure to hold the contact lens package securely in place, holding the dexterity tool in a closed position with a first hand while removing a portion of a lid of the contact lens package with a second hand, and removing the contact lens from the contact lens package.

Some embodiments of the method also provide for opening the dexterity tool; and removing the contact lens package from the dexterity tool. Some embodiments of the method also provide for aligning a tab extending from the contact lens package with an aperture placed in the dexterity tool. Some embodiments of the method also provide for reaching through an opening in the dexterity tool to grasp a tail of the lid on the contact lens package. Some embodiments of the method also provide where the step of holding the dexterity tool in a closed position with a first hand while removing a portion of a lid of the contact lens package with a second hand is performed while holding the dexterity tool in the palm of the user's hand with a thumb on one side of the dexterity tool and fingers on the opposite side of the dexterity tool.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

These drawings illustrate certain aspects of some of the embodiments of the present disclosure and should not be used to limit or define the method.

FIG. 1 is a top perspective view of an exemplary dexterity tool where the tool is shown in the open position.

FIG. 2 is a side projection view of the embodiment shown in FIG. 1.

FIG. 3 is a top projection view of the embodiment shown in FIG. 1, and indicating the section line A-A.

FIG. 4 is a section view taken from section line A-A shown in FIG. 3.

FIG. 5 is a top perspective view of the embodiment shown in FIG. 1 where the tool is in the closed position.

FIG. 6 is a side projection view of the embodiment shown in FIG. 5.

FIG. 7 is a front projection view of the embodiment shown in FIG. 5.

FIG. 8 is a top projection view of a dexterity tool, and indicating the section line B-B.

FIG. 9 is a section view taken along the section line B-B shown in FIG. 8.

FIG. 10 is a top perspective view of one type of contact lens package where the lid and contact lens has been removed and the location for Detail A is shown.

FIG. 11 is a detailed view of Detail A shown in FIG. 10.

FIG. 12 is a top perspective view of another type of contact lens package where the lid and contact lens has been removed and the location for Detail B is shown.

FIG. 13 is a detailed view of Detail B shown in FIG. 12.

FIG. 14 is a top projection view of another type of contact lens package where the lid and contact lens has been removed.

FIG. 15 is a side projection view of the contact lens package shown in FIG. 14.

FIG. 16 is a top projection view of an exemplary dexterity tool after inserting one type of contact lens package and closing the tool.

FIG. 17 is a top projection view of the dexterity tool in FIG. 16 where the lid of the contact lens package has been partially removed to expose the contact lens.

FIG. 18 is a top projection view of an exemplary dexterity tool after inserting another type of contact lens package and closing the tool.

FIG. 19 is a top projection view of the dexterity tool in FIG. 18 where the lid of the contact lens package has been partially removed to expose the contact lens.

FIG. 20 is a top projection view of the dexterity tool in FIG. 18 where the contact lens has been removed and the tool has been opened.

### DETAILED DESCRIPTION

Provided herein are several embodiments of a dexterity tool for opening a hermetically sealed contact lens package to remove a contact lens inside. There is increasing interest in reducing plastic usage, including in contact lens packaging. However, making the contact lens primary package (the foil sealed “blister”) smaller can make the package more difficult to open, particularly by young new contact lens users and by other wearer groups with diminished dexterity. This may be exacerbated by the fact that the heat seal between the plastic base and the foil lid is often quite strong to maintain a sterile seal through autoclaving. The strength of the heat seal between the package base and lid may cause, upon removal of the lid, the lens to catapult from the package base to a non-sterile surface like a bathroom counter or floor. The packaging solution may also be spilled creating a mess and decreasing the available volume of packaging solution for rinsing the lens if the first lens insertion step is not successful. The dexterity tool of the present invention addresses these problems.

The tool has a top clamshell housing with a movable jaw connected to the top clamshell housing and an opening in the top clamshell housing. The tool may also include a bottom clamshell housing hingedly attached to the top clamshell housing so that the top housing hinges about a hinge axis relative to the bottom housing and further contains a bowl positioned within the bottom clamshell housing and a platform surrounding the bowl. A fixed jaw may be connected to the platform such that when the tool is placed in a closed position the contact lens package is sandwiched in between the movable jaw and the fixed jaw.

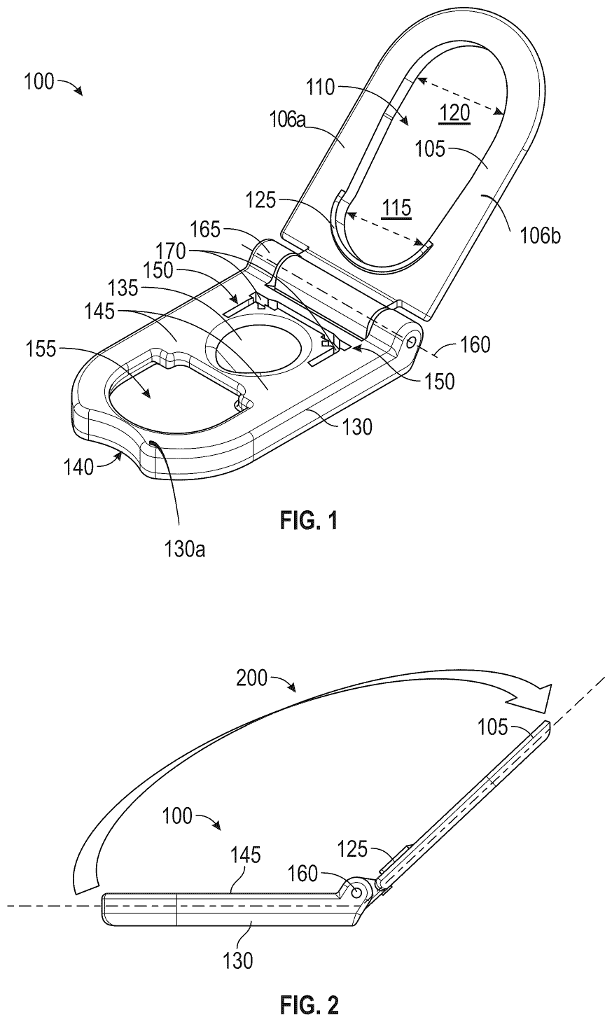

FIG. 1 is a top perspective view of an exemplary dexterity tool 100 where the tool is shown in the open position. A top clamshell housing 105 may be hingedly connected to a bottom clamshell housing 130 about a hinge axis 160. The top clamshell housing 105 may be rectangular, rectangular with one or both of the distal and proximal ends being rounded, have an elliptical shape, “O” shape, or oval shape with an opening 110 in the center. The width of the opening 110 varies between a proximal width 115 at the proximal end of the top clamshell housing 105 close to the hinge axis 160, and a distal width 120 which is located on the distal end of the clamshell housing 105. The distal width 120 may be larger than the proximal width 115. Adjacent to the proximal width 115 is a movable jaw 125 which is used to provide a clamping force against the deck of a contact lens package, as will be described further below. The movable jaw 125 may be curved or arched and should connect between the two points measuring across the proximal width 115. Movable jaw 125 may engage the back or the back and only a portion of the sides of the contact lens package to enable removal of the lid. The proximate portion of the top housing 105 may be square or flat to align with the hinge 165 while the distal portion of the top housing may have any shape suitable for the user to grip the distal end, including, rounded, square polygonal, triangular, any of which may have rounded edges, oval and the like. Within the opening 110, the two opposing sides 106a and 106b of the opening 110 are generally straight while the proximal side (closest to the hinge) is rounded as well as the distal side (furthest from the hinge).

The bottom clamshell housing 130 has a proximate end which is flat and contains a hinge 165. The opposing distal end 130a of the clamshell housing 130 may have any of the shapes described above, including an arch shape and may contain a notch 140, which helps to open and close the tool 100 by exposing a portion of the top clamshell housing 105 so that a user can more easily separate the bottom housing 130 from the top housing 105. The distal end 130a of the bottom housing 130 also may contain an opening 155. The opening may be sized to allow the user to place a finger through opening 155 to improve the grip on the distal end 130a. The shape of opening 155 may mirror the shape of distal end 130 or may have a different shape. As shown in FIG. 1 the opening has an arch shape on the distal portion and is flattened on the proximate portion to form a “D” shape. A bowl cavity 135 is provided near the center of the bottom housing 130 and connects between the opening 155 and the package aperture 170 which may be adjacent to the hinge 165. Bowl cavity 135 may have sides and a bottom with inner dimensions larger than the exterior dimensions of the contact lens package or may be an opening that allows the contact lens bowl to extend below the underside of clamshell housing 130. Package aperture 170 may be one or more apertures sized and positioned to accept a portion of a contact lens package so that the package can be held securely when closing the tool and clamping. Additionally, they allow the contact lens package to sit flat atop platform 145 and the fixed jaw 150 portions of the bottom housing 130.

FIG. 2 is a side projection view of the embodiment shown in FIG. 1 showing the open angle 200 which is the angle between the top housing 105 and bottom housing 130. In FIG. 2 tool 100 has been opened to approximately 135 degrees but there is no requirement for any specific open angle for any embodiment herein. Some tools 100 may have an open angle that is almost 180 degrees or more, while others might have an open angle as small as 45 degrees. All that is required for any embodiment is to provide enough of an open angle 200 so that the tool 100 can be adequately opened (top housing 105 hingedly rotated away from the bottom housing 130) to allow the insertion of a contact lens package and later removal once the package is opened and the lens has been removed from the package.

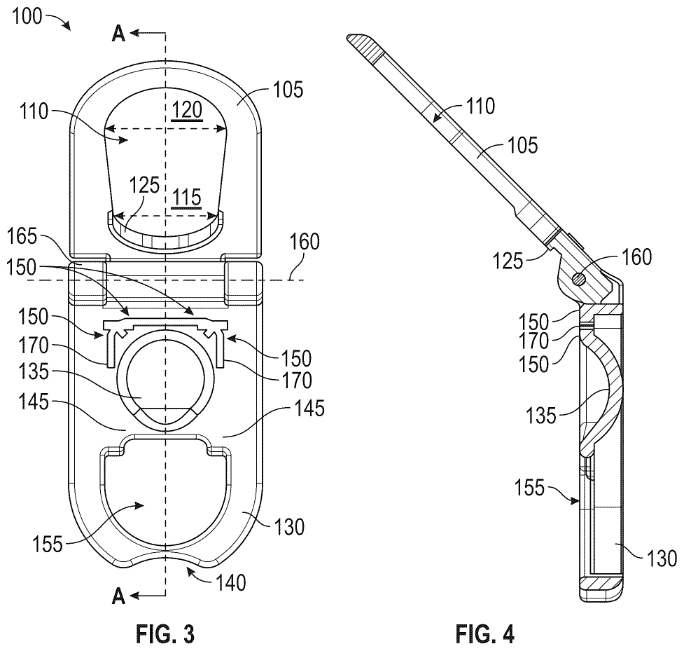

FIG. 3 is a top projection view of the embodiment shown in FIG. 1 and indicates the section line A-A down the central axis of the tool. As shown, the tool 100 is generally symmetrical about this vertical central axis but this is not required. The platform 145 may surround the bowl cavity 135 which is aligned down the center of the tool. The package aperture 170 is essentially one or more holes, notches, depressions, groves or the like located in platform 145 between the bowl cavity 135 and hinge 165. Here the aperture 170 surrounds the proximal end of the bowl cavity 135 and provides a U-shape that is oriented convexly in this view. While this design for the aperture 170 is shown in FIG. 3, any other shape that allows the contact lens package to sit flat atop the platform 145 and/or so that the tool 100 including moveable jaw 125 and fixed jaw 150 can adequately engage with the package to hold it secure enough while removing the lid may be employed.

FIG. 4 is a section view taken from section line A-A shown in FIG. 3. When cutting down the center of the lower housing 130 it can be observed that there is a large opening 155 down the middle with the only real feature being the bowl cavity 135, aperture 170, and the fixed jaw 150 portion of the platform that can be observed. Similarly, the top housing 105 contains a large opening 110 which comprises the entire central portion of the top housing 105. The opening 110 may be elliptical with a proximate apex near the hinge 165 and a distal apex on the opposite side of the housing 105. The movable jaw 125 is shown near the proximate end of the top housing 105, and as the tool closes the movable jaw 125 rotates about the hinge axis 160 until contacting the fixed jaw 150 portions of the platform 145. The movable jaw 125 ideally should provide some pressure or clamping force to the platform area that contains the aperture 170, which is also the area generally referred to as the fixed jaw 150. This clamping force can help squeeze the package features into the aperture 170 and hold the package securely while removing the lid.

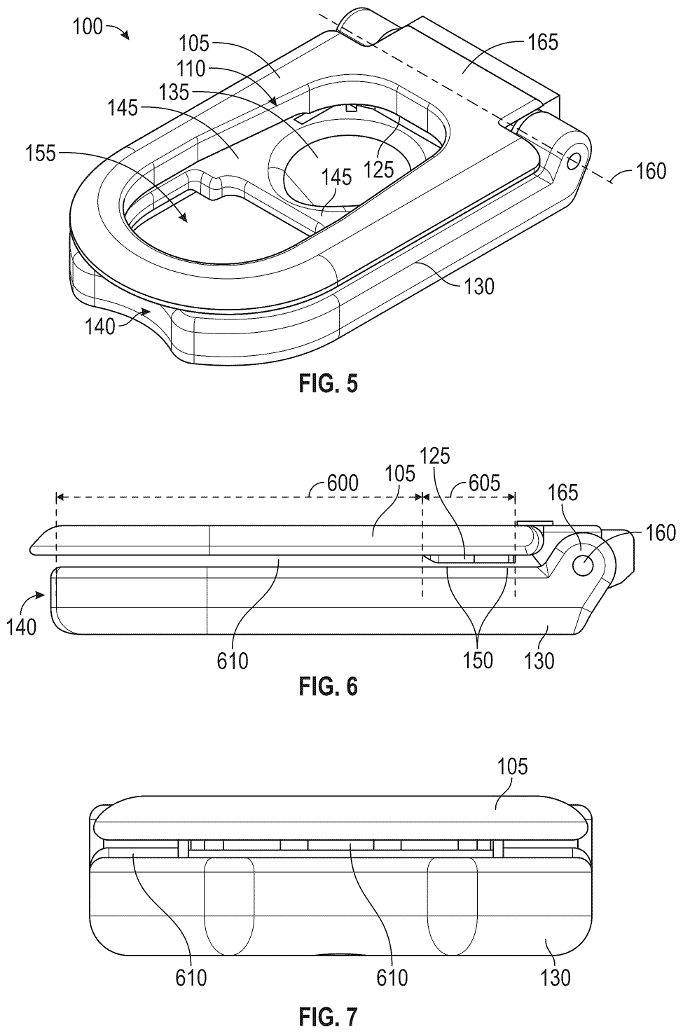

FIG. 5 is a top perspective view of the embodiment shown in FIG. 1 where the tool 100 is in the closed position. To fully close the tool 100, the top housing 105 is hingedly rotated about the hinge axis 160 relative to the bottom housing 130 until the movable jaw 125 contacts the fixed jaw 150 portion of the platform 145. Once closed, only the distal portions of the platform 145 are visible though the opening 110 as the proximal portions of the platform 145 are covered by the proximal area of the top housing 105 which includes the movable jaw 125. The bowl cavity 135 remains uncovered even when the tool 100 is closed due to the opening 110 which is positioned directly above the bowl cavity 135 when the tool 100 is closed.

FIG. 6 is a side projection view of the embodiment shown in FIG. 5. The interface between the top housing 105 and the bottom housing 130 can be described as having two portions. A first portion is the clamping portion 605 which is defined as the area where the movable jaw 125 and the fixed jaw 150 are vertically aligned with one another (where the movable jaw 125 may be above the fixed jaw 150 during operation). The clamping portion 605 is where the movable jaw 125 should be pressing downwardly on the package to ‘clamp’ the package between the top housing 105 and the bottom housing 130 while the user removes the lid. The movable jaw 125 and fixed jaw 150 may be in contact when the tool 100 is closed or there might be a small gap to allow for the thickness of the deck 1010 on the package (described in more detail below). The second portion is a clearance portion 600 defined by a gap 610 between the top housing 105 and the bottom housing 130. The clamping portion 605 is proximal to the hinge 165 while the clearance portion 600 is distal to the hinge 165.

FIG. 7 is a front projection view of the embodiment shown in FIG. 5. The gap 610 may wrap around the front side of the tool 100, connecting with the gap 610 on the left hand side and right hand side of the tool 100. The gap allows the lid to be peeled away from the package deck 1010 and heat seal portion.

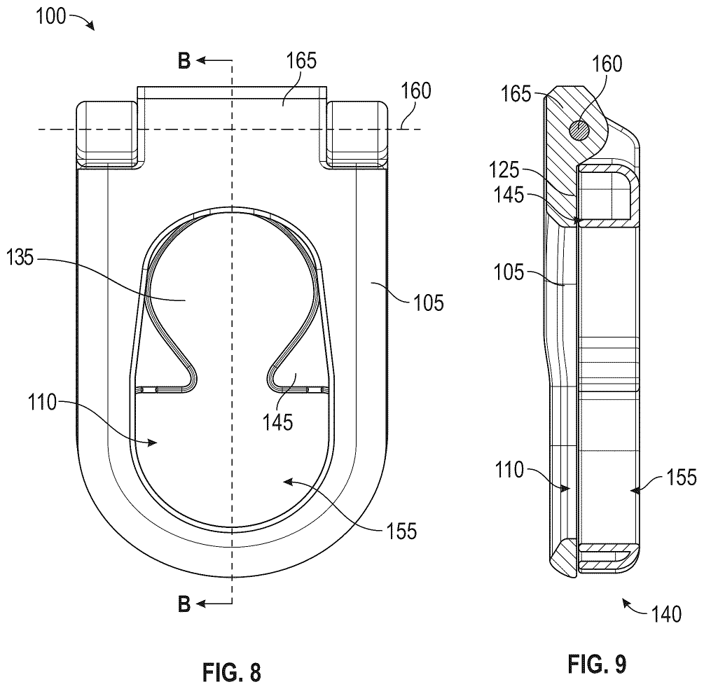

FIG. 8 is a top projection view of dexterity tool having a bowl cavity 135 without a well or base and which is open to opening 155. The section line B-B is positioned along the central axis of the tool 100. As shown, the tool 100 is generally symmetrical about this central axis, however the position of the opening between bowl cavity 135 and opening 155 can be off center for nonsymmetric package shapes. The opening 110 in the top housing 105 allows the bowl cavity 135 of the bottom housing 130 to be completely exposed and visible through the top housing 105. The platform 145 wraps around the bowl cavity 135 and should be planar and substantially flat. During the clamping action, the deck of the package should rest flat against the platform 145 and the interfacing surfaces on each component should be parallel.

FIG. 9 is a section view taken along the section line B-B shown in FIG. 8. When closed, the opening 110 in the top housing may be aligned with the opening 155 in the bottom housing. The movable jaw 125 may be adjacent to or in contact with the proximate portion of the platform 145 near the aperture 170 which is also referred to as the fixed jaw 150 portion of the tool 100. The notch 140 in the bottom housing 130 creates an overhang where the top housing 105 is longer than the bottom housing 130. This overhang created by the notch 140 provides additional surface area for the user to open the tool 100 and discard the contact lens package after removing the contact lens. This optional notch 140 has been found to aid in the opening and closing of the tool 100.

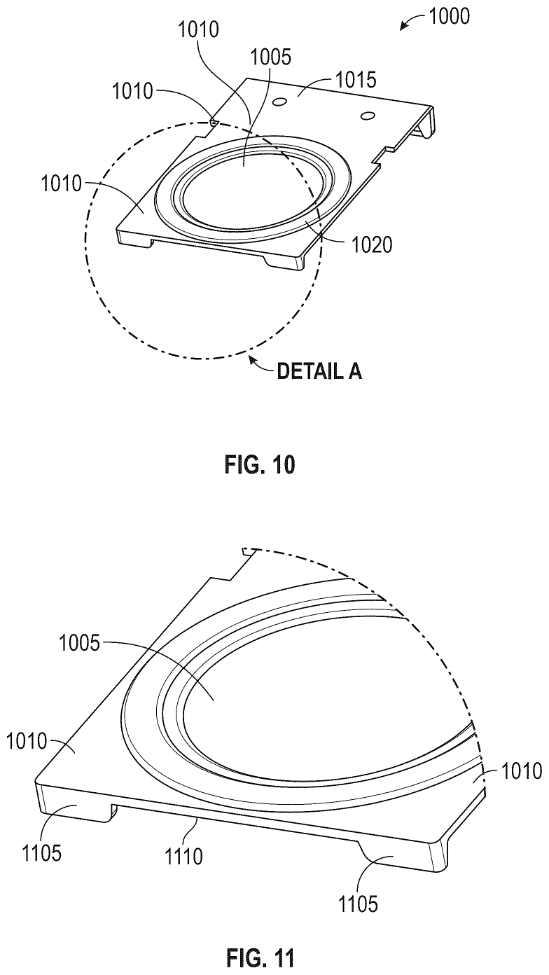

FIG. 10 is a top perspective view of one type of contact lens package 1000 where the lid and contact lens has been removed and the location for Detail A is shown. In this package 1000, a bowl 1005 is placed near the center with a deck 1010 extending horizontally from the bowl 1005 in every direction. Additionally, this package 1000 further includes a deck extension 1015, which is an extension of the deck 1010 in one direction. In this embodiment, the extension 1015 extends horizontally and parallel to the deck 1010. In normal use, the deck extension 1015 provides additional surface area for the user to grasp the deck with one hand while removing the lid using the other hand. Contact lens packages come in a wide variety of shapes and tools of the present invention may be designed to open any of them.

FIG. 11 is a detailed view of Detail A shown in FIG. 10. In this embodiment, a pair of outer tabs 1105 extend downwardly from the deck 1010, where one tab 1105 is placed at one corner of the deck 1010 and the second tab 1105 placed on an opposite corner of the deck 1010. Here, a notch 1110 is located between the two tabs 1105, where the notch 1110 is a portion of the package where the deck 1010 does not extend downwardly, or the deck 1010 has no tabs where the notch 1110 is located. In some embodiments, the tabs 1105 do not extend across the entire width of the package 1000, but instead have a gap between them or notch 1110 as shown here. The aperture 170 may be a pair of access holes that are shaped and positioned to accept the outer tabs 1105 of the package 1000 as the tool 100 is closed which results in a clamping force being applied downwardly onto the outer tabs 1105 to push the tabs 1105 through the aperture(s) 170 until the deck 1010 is at or near flush against the platform 145.

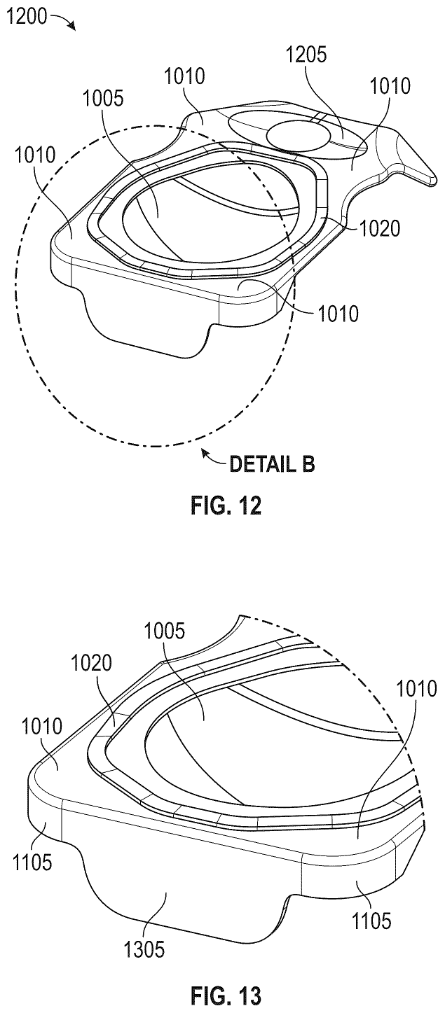

FIG. 12 is a top perspective view of another type of contact lens package 1200 where the lid and contact lens has been removed and the location for Detail B is shown. In this package 1200, a bowl 1005 is placed near the center with a deck 1010 extending horizontally from the bowl 1005 in every direction. Additionally, this package 1000 further includes a deck extension 1205, which is an extension of the deck 1010 in one direction. In this embodiment, the extension 1205 is sloped away from the bowl 1005 and is generally not parallel to the deck 1010.

FIG. 13 is a detailed view of Detail B shown in FIG. 12. In this embodiment, a pair of outer tabs 1105 extend downwardly from the deck 1010, where one tab 1105 is placed at one corner of the deck 1010 and the second tab 1105 placed on an opposite corner of the deck 1010. Here, a center tab 1305 is located between the two outer tabs 1105, where the center tab 1305 extends further downward than the outer tabs 1105. In some embodiments, the length of the center tab 1305 (measured vertically down from the deck 1010) is approximately twice the length of the outer tabs 1105 (measured vertically down from the deck 1010). The aperture 170 may be a series of access holes or one large access slot that is shaped and positioned to accept the outer tabs 1105 as well as the center tab 1305 of the package 1200 as the tool 100 is closed which results in a clamping force being applied downwardly onto the outer tabs 1105 and center tab 1305 to push the tabs 1105/1305 through the aperture(s) 170 until the deck 1010 is at or near flush against the platform 145.

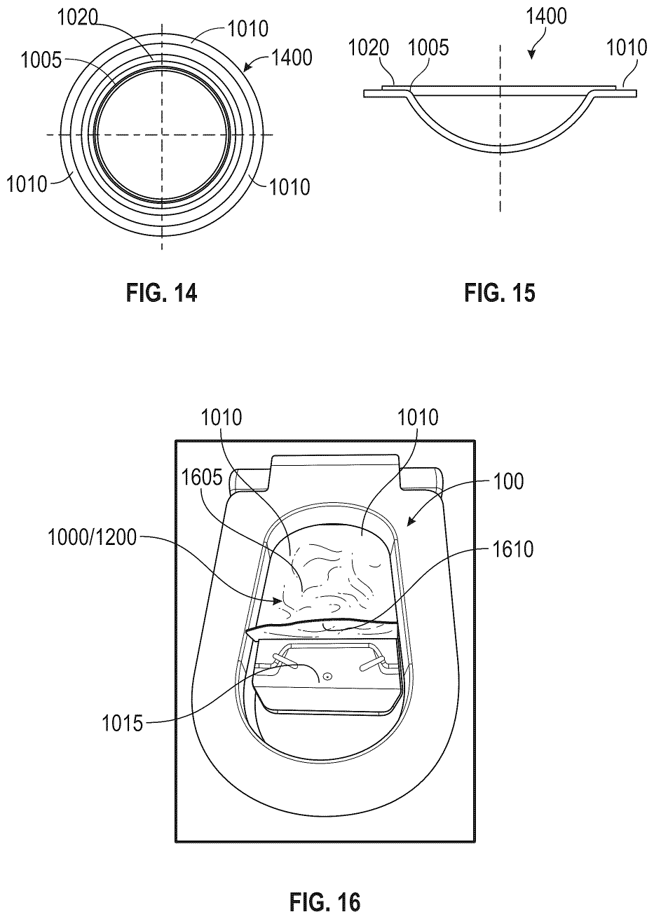

FIG. 14 is a top projection view of another type of contact lens package 1400 where the lid and contact lens has been removed. This type of package 1400 is generally referred to in the art as a “dome only” style. As used herein, the term “dome only” style is used to refer to a contact lens package that does not contain a deck extension or even a substantial deck or beyond the heat seal. In this dome only package 1400, the bowl 1005 has a heat seal region 1020 extending around the rim of the bowl where the lid is heat sealed to the bowl. Deck 1010 extends horizontally from the heat seal region 1020 in every direction. In this embodiment, the deck 1010 is minimized to minimize plastic use, and extends equidistantly about the bowl 1005 and heat seal region in each direction but this is not required. The present tool enables the use of such a dome only package which would otherwise be difficult to open without a deck extension.

FIG. 15 is a side projection view of the contact lens package shown in FIG. 14. It is important to note that this package 1400 does not contain any tabs that extend downwardly from the deck 1010. There is only the deck 1010 which extends horizontally to surround a perimeter of the bowl 1005 and extend outwardly from said perimeter of the bowl 1005. With this package 1400, since there are no tabs, the movable jaw 125 provides a clamping force which may squeeze a portion of the deck 1010 which is located between the bowl cavity 1005, outside the heat seal region 1020 and the hinge 165.

As is known in the art, the contact lens sits within the bowl 1005 of each package and the lid would be sealed to the heat seal region 1020 to prevent leaking of solution or invasion of foreign materials.

FIG. 16 is a top projection view of an exemplary dexterity tool 100 after inserting one type of contact lens package and closing the tool 100. Here the package used can be either package 1000 or package 1200 as both would operate in a similar way. To begin, the tool 100 is opened and the bowl 1005 of the package is aligned with the bowl cavity 135 of the tool. Additionally, the tabs 1105 and 1305 (shown in FIG. 13) if present on the contact lens package are aligned with the aperture(s) 170 (shown in FIG. 1) on the tool 100 and once this is done the tool 100 is closed until the package deck 1010 is at or near flush against the platform 145 or there is adequate clamping force applied to the package deck 1010 by the movable jaw 125 that the package 1000/1200 is secure enough to begin removal of the package lid 1605. The removal of the package lid 1605 begins with separating the deck extension 1015 from a portion of the package lid 1605 near the edge of the package lid 1605 and facing the user until there is a tail 1610 to grasp by the user to further separate the package lid 1605 from the deck 1010. While holding the tool 100 closed, the user can then easily pull upwardly on the tail and towards the hinge with a greatly improved grip on the package, a large increase in available surface areas to grasp, and much more stability so that the lens does not fall out of the package during opening and become lost or contaminated.

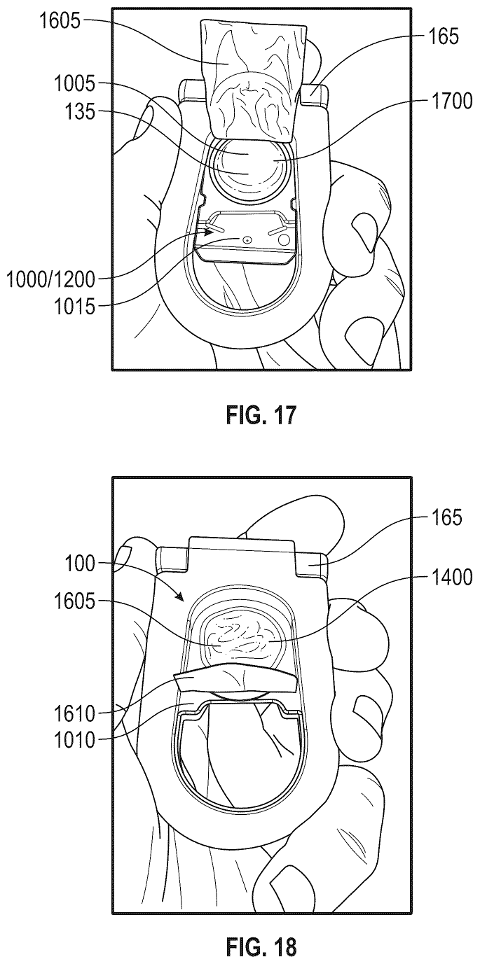

FIG. 17 is a top projection view of the dexterity tool in FIG. 16 where the package lid 1605 of the contact lens package has been further removed to expose the contact lens 1700 for removal by the user. The contact lens 1700 is aligned with the bowl 1005 of the package which is further aligned with the bowl cavity 135 of the bottom housing 130. During this step the user may hold the tool 100 in the palm of their hand (either left hand or right hand) with a thumb on one side of the tool, fingers on the opposing side of the tool, with an optional index finger placement for additional stability along the top of the tool near the hinge 165. For packages 1000/1200 which utilize the extended deck 1015, the openings 110 and 155 align with one another to allow the space for the extended deck 1015 to extend without interference with the tool and allows different types of packages with different geometry for their decks to be utilized with embodiments of the tool. The alignment of openings 110 and 155 also allows space for the user to grasp the tail 1610 of the package lid 1605 for easier removal.

FIG. 18 is a top projection view of an exemplary dexterity tool 100 after inserting another type of contact lens package 1400 and closing the tool 100. For this package 1400, there are no tabs so the user only needs to open the tool 100 and align the bowl 1005 of the package with the bowl cavity 135 of the tool. Once this is done the tool 100 is closed until the deck 1010 is at or near flush against the platform 145 or there is adequate clamping force applied to the deck 1010 by the movable jaw 125 so that the package 1000/1200 is secure enough to begin removal of the package lid 1605. The removal of the package lid 1605 begins with separating the package lid 1605 from a portion of deck extension 1015 near the edge of the package lid 1605 and facing the user until there is a tail 1610 to grasp by the user to further separate the package lid 1605 from the deck 1010. While holding the tool 100 closed, the user can then easily pull upwardly on the tail 1610 and towards the hinge.

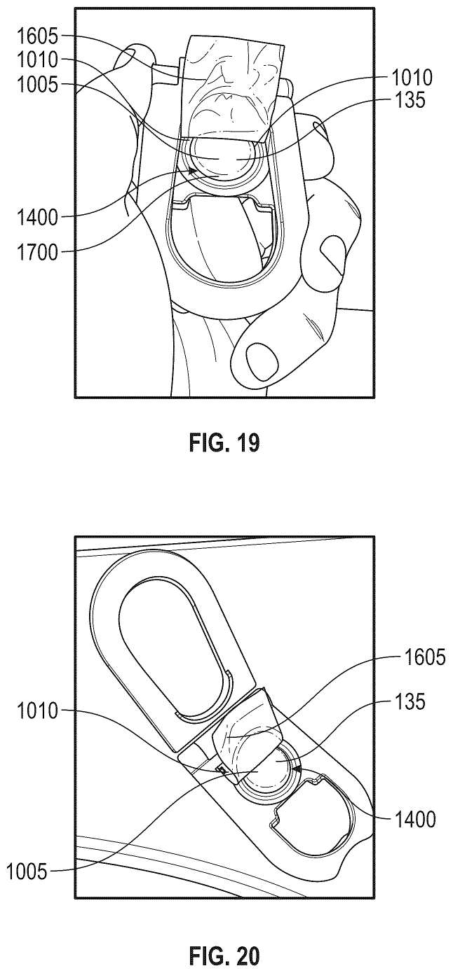

FIG. 19 is a top projection view of the dexterity tool in FIG. 18 where the package lid 1605 of the contact lens package 1400 has been partially removed to expose the contact lens 1700. In this state, the user can now easily remove the contact lens 1700 and insert the lens into their eye.

FIG. 20 is a top projection view of the dexterity tool in FIG. 18 where the contact lens 1700 has been removed and the tool 100 has been opened. With the tool in this position, the remnants of the package 1400, package lid 1605, and any solution may be removed from the tool and discarded.

The hinge 165 may be any type of hinge including but not limited to: a traditional hinge where a single elongate rod of material passes through one or more female apertures on both the top housing 105 and bottom housing 130 (as shown herein), a snap hinge where no separate elongate rod is used but instead each housing 105/130 includes a short rod as well as a female snap so that the short rod of one housing snaps into the female snap on the opposing housing to connect the housings together while permitting them to hinge about the hinge axis, and a living hinge where the top housing 105 forms a single continuous piece with the bottom housing 130 such that the two housings are connected by a piece of flexible material that is made from the same base material as both housings. All that is required for the hinge 165 is that is permits the top housing 105 to rotate relative to the bottom housing 130 about the hinge axis 160. It is further possible to have an embodiment that does not include a hinge at all, with all of the remaining components described and shown herein.

The tool can be constructed with any number of different materials including but not limited to: plastic, metal, composite, and wood, as well as any combination of these. The tool can further be made out of recycled or virgin materials or some combination.

It has been discovered that the embodiments herein provide a number of advantages over prior devices. For users with limited dexterity or grip strength, they can struggle to hold the package with one hand while peeling off the lid with the other hand. The forces required and the limited area for gripping the package can result in ‘springboarding’ where the contact lens is projected out of the container as soon as the lid is removed, due to the force needed to remove the lid from the package and loading of the package (bending of the package) when removing the lid. During ‘springboarding’ not only will the contact lens be ejected, but the solution can also spill or splash onto the user or surrounding surfaces. Due to the required dexterity to open a traditional package, some users simply cannot use contact lenses as they lack the required dexterity and/or grip strength.

The tool of the present invention also provides a larger surface area for the user to grip, thereby providing more stability during package opening.

The embodiments herein solve a number of these problems by providing a larger surface area for the user to grab ahold of, which in turn provides more stability and control over the package when removing the lid. The embodiments of the dexterity device herein can be used with either hand, in a variety of orientations and generally any squeezing process can be used. For example, the clamping action described and shown herein can be performed by using the palm of the hand to squeeze the movable jaw against the fixed jaw and hold this positioned closed during removal of the lid. This process can also be performed by pinching the top and bottom clamshell housings together with the fingers of either one hand or both hands, or the dexterity device can sit atop a counter/surface and the user can press the top clamshell housing downwardly to apply the pressure to hold the package in place during removal of the lid.

### EMBODIMENTS

1. A dexterity tool for removing the lid of a hermetically sealed contact lens package, the tool comprising:
   a housing which clamps down on the contact lens package to aid in the removal of the lid from the contact lens package.
2. The dexterity tool of any of the foregoing or preceding dexterity tool embodiments wherein the housing comprises:
   a top clamshell housing hingedly attached to a bottom clamshell housing.
3. The dexterity tool any of the foregoing or preceding dexterity tool embodiments further comprising:
   a movable jaw positioned on the top clamshell housing; and
   a fixed jaw positioned on the bottom clamshell housing.
4. The dexterity tool of any of the foregoing or preceding dexterity tool embodiments wherein:
   the movable jaw is an arch.
5. The dexterity tool of any of the foregoing or preceding dexterity tool embodiments further comprising:
   an opening in the top clamshell housing which allows access to the lid while the tool is in a closed position.
6. The dexterity tool of any of the foregoing or preceding dexterity tool embodiments further comprising:
   a cavity positioned within the bottom clamshell housing.
7. The dexterity tool of any of the foregoing or preceding dexterity tool embodiments further comprising:
   a platform surrounding the cavity.
8. The dexterity tool of any of the foregoing or preceding dexterity tool embodiments wherein:
   a proximal portion of the top housing is flat and
   a distal portion of the top housing is rounded.
9. A dexterity tool for removing the lid of a contact lens package, the tool comprising:
   a movable jaw which moves towards a fixed jaw to clamp the contact lens package between the movable jaw and fixed jaw during removal of the lid.
10. The dexterity tool of any of the foregoing or preceding dexterity tool embodiments wherein:
   the movable jaw extends from a top clamshell housing.
11. The dexterity tool of any of the foregoing or preceding dexterity tool embodiments wherein:
   the fixed jaw is positioned on a bottom clamshell housing.
13. The dexterity tool of any of the foregoing or preceding dexterity tool embodiments wherein:
   a user can grasp the lid of the contact lens package while the contact lens package is clamped between the movable jaw and fixed jaw.
14. The dexterity tool of any of the foregoing or preceding dexterity tool embodiments wherein:
   the lid is uncovered by the top clamshell housing when the tool is closed.
15. The dexterity tool of any of the foregoing or preceding dexterity tool embodiments wherein:
   when the tool is placed in a closed position the user has more control over the contact lens package while removing the lid.
16. A method for using a dexterity tool to open a contact lens package, the method comprising:
   opening the dexterity tool;
   positioning the contact lens package within the tool;
   closing the dexterity tool;
   holding the dexterity tool in a closed position while removing a portion of a lid of the contact lens package.
17. The method of any of the foregoing or preceding method embodiments wherein:
   the step of positioning the contact lens package within the tool comprises aligning a bowl in the contact lens package with a cavity in the dexterity tool.
18. The method of any of the foregoing or preceding method embodiments further comprising:
   aligning a tab extending from the contact lens package with an aperture placed in the dexterity tool.
19. The method of any any of the foregoing or preceding method embodiments further comprising:
   reaching through an opening in the dexterity tool to grasp a tail of the lid on the contact lens package.
20. The method any of the foregoing or preceding method embodiments wherein:
   the step of holding the dexterity tool in a closed position is performed with a first hand while the step of removing a portion of a lid of the contact lens package is performed with a second hand.
21. A dexterity tool for opening a contact lens package to remove a contact lens inside, the tool comprising:
   a top clamshell housing comprising;
      a movable jaw connected to the top clamshell housing; and
      an opening in the top clamshell housing; and
   a bottom clamshell housing hingedly attached to the top clamshell housing so that the top housing hinges about a hinge axis relative to the bottom clamshell housing, the bottom clamshell housing comprising;
      a cavity positioned within the bottom clamshell housing;
      a platform surrounding the cavity; and
      a fixed jaw connected to the platform such that when the tool is placed in a closed position the contact lens package is sandwiched in between the movable jaw and the fixed jaw.
22. The dexterity tool of any of the foregoing or preceding dexterity tool embodiments wherein:
   the opening comprises a proximal width located at a proximal end of the top clamshell housing, and a distal width located at a distal end of the top clamshell housing.
23. The dexterity tool of any of the foregoing or preceding dexterity tool embodiments wherein:
   the distal width is larger than the proximal width.
25. The dexterity tool of any of the foregoing or preceding dexterity tool embodiments further comprising:
   an aperture sized to accept a portion of the contact lens package.
26. The dexterity tool of embodiment 25 wherein:
   the aperture comprises one or more holes within the platform.
27. The dexterity tool of embodiment 25 or 26 wherein:
   the aperture is placed between the cavity and the hinge axis.
28. The dexterity tool of any of the foregoing or preceding dexterity tool embodiments wherein:
   a proximal portion of the top housing is flat and
   a distal portion of the top housing is rounded.
29. A dexterity tool for opening a contact lens package having a bowl, a deck, and at least one tab extending from the deck; the tool comprising:
   a top clamshell housing comprising;
      a movable jaw connected to a proximate end of the top clamshell housing; and
      an opening in the top clamshell housing;
   a bottom clamshell housing comprising;
      a cavity positioned within the bottom clamshell housing;
      a platform surrounding the cavity;
      an aperture in the platform sized to accept the at least one tab; and
      a fixed jaw connected to the platform and surrounding the aperture; and
   a hinge connecting the top clamshell housing with the bottom clamshell housing.
30. The dexterity tool of any of the foregoing or preceding dexterity tool embodiments wherein:
   the movable jaw extends from a proximate edge of the opening in the top clamshell housing.
31. The dexterity tool of any of the foregoing or preceding dexterity tool embodiments wherein:
   the tool has a clamping portion that is proximate to the hinge and a clearance portion that is distal to the hinge.
32. The dexterity tool of any of the foregoing or preceding dexterity tool embodiments wherein:
   the cavity of the bottom clamshell housing is sized to accept the bowl of the contact lens package.
33. The dexterity tool of any of the foregoing or preceding dexterity tool embodiments wherein: the top clamshell housing has an elliptical shape.
34. The dexterity tool of any of the foregoing or preceding dexterity tool embodiments wherein:
   the opening is aligned with the bowl of the package and the cavity of the bottom housing when the device is in a closed position.
35. The dexterity tool of any of the foregoing or preceding dexterity tool embodiments wherein:
   when the tool is placed in a closed position the deck of the contact lens package is sandwiched in between the movable jaw and the fixed jaw.
36. A method for using a dexterity tool to open a contact lens package to remove a contact lens, the method comprising:
   opening the dexterity tool;
   aligning a bowl in the contact lens package with a bowl in the dexterity tool;
   closing the dexterity tool until there is enough clamping pressure to hold the contact lens package securely in place;
   holding the dexterity tool in a closed position with a first hand while removing a portion of a lid of the contact lens package with a second hand; and
   removing the contact lens from the contact lens package.
37. The method of any of the foregoing or preceding method embodiments further comprising:
   opening the dexterity tool; and
   removing the contact lens package from the dexterity tool.
38. The method of any of the foregoing or preceding method embodiments further comprising:
   aligning a tab extending from the contact lens package with an aperture placed in the dexterity tool.
39. The method of any of the foregoing or preceding method embodiments further comprising:
   reaching through an opening in the dexterity tool to grasp a tail of the lid on the contact lens package.
40. The method of any of the foregoing or preceding method embodiments wherein:
   the step of holding the dexterity tool in a closed position with a first hand while removing a portion of a lid of the contact lens package with a second hand is performed while holding the dexterity tool in the palm of the user's hand with a thumb on one side of the dexterity tool and fingers on the opposite side of the dexterity tool.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.
Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A dexterity tool for removing the lid of a hermetically sealed contact lens package, the tool comprising:
a housing which clamps down on the contact lens package to aid in the removal of the lid from the contact lens package.

2. The dexterity tool of claim 1 wherein the housing comprises:
a top clamshell housing hingedly attached to a bottom clamshell housing.

3. The dexterity tool of claim 2 further comprising:
a movable jaw positioned on the top clamshell housing; and
a fixed jaw positioned on the bottom clamshell housing.

4. The dexterity tool of claim 3 wherein:
the movable jaw is an arch.

5. The dexterity tool of claim 1 further comprising:
an opening in the top clamshell housing which allows access to the lid while the tool is in a closed position.

6. The dexterity tool of claim 1 further comprising:
a bowl cavity positioned within the bottom clamshell housing.

7. The dexterity tool of claim 6 further comprising:
a platform surrounding the bowl cavity.

8. The dexterity tool of claim 2 wherein:
a proximal portion of the top housing is flat and
a distal portion of the top housing is rounded.

9. A dexterity tool for removing the lid of a contact lens package, the tool comprising:
a movable jaw which moves towards a fixed jaw to clamp the contact lens package between the movable jaw and fixed jaw during removal of the lid.

10. The dexterity tool of claim 9 wherein:
the movable jaw extends from a top clamshell housing.

11. The dexterity tool of claim 9 wherein:
the fixed jaw is positioned on a bottom clamshell housing.

12. The dexterity tool of claim 10 further comprising:
a bottom clamshell housing hingedly attached to the top clamshell housing.

13. The dexterity tool of claim 9 wherein:
a user can grasp the lid of the contact lens package while the contact lens package is clamped between the movable jaw and fixed jaw.

14. The dexterity tool of claim 10 wherein:
the lid is uncovered by the top clamshell housing when the tool is closed.

15. The dexterity tool of claim 9 wherein:
when the tool is placed in a closed position the user has more control over the contact lens package while removing the lid.

16. A method for using a dexterity tool to open a contact lens package, the method comprising:
opening the dexterity tool;
positioning the contact lens package within the tool;
closing the dexterity tool;
holding the dexterity tool in a closed position while removing a portion of a lid of the contact lens package.

17. The method of claim 16 wherein:
the step of positioning the contact lens package within the tool comprises aligning a bowl in the contact lens package with a bowl cavity in the dexterity tool.

18. The method of claim 16 further comprising:
aligning a tab extending from the contact lens package with an aperture placed in the dexterity tool.

19. The method of claim 16 further comprising:
reaching through an opening in the dexterity tool to grasp a tail of the lid on the contact lens package.

20. The method of claim 16 wherein:
the step of holding the dexterity tool in a closed position is performed with a first hand while the step of removing a portion of a lid of the contact lens package is performed with a second hand.

21. A dexterity tool for opening a contact lens package to remove a contact lens inside, the tool comprising:
a top clamshell housing comprising;
a movable jaw connected to the top clamshell housing; and
an opening in the top clamshell housing; and
a bottom clamshell housing hingedly attached to the top clamshell housing so that the top housing hinges about a hinge axis relative to the bottom clamshell housing, the bottom clamshell housing comprising;
a bowl cavity positioned within the bottom clamshell housing;
a platform surrounding the bowl cavity; and
a fixed jaw connected to the platform such that when the tool is placed in a closed position the contact lens package is sandwiched in between the movable jaw and the fixed jaw.

22. The dexterity tool of claim 21 wherein:
the opening comprises a proximal width located at a proximal end of the top clamshell housing, and a distal width located at a distal end of the top clamshell housing.

23. The dexterity tool of claim 22 wherein:
the distal width is larger than the proximal width.

24. The dexterity tool of claim 21 wherein:
the movable jaw is an arch.

25. The dexterity tool of claim 21 further comprising:
an aperture sized to accept a portion of the contact lens package.

26. The dexterity tool of claim 25 wherein:
the aperture comprises one or more holes within the platform.

27. The dexterity tool of claim 25 wherein:
the aperture is placed between the bowl cavity and the hinge axis.

28. The dexterity tool of claim 21 wherein:
a proximal portion of the top housing is flat and
a distal portion of the top housing is rounded.

29. A dexterity tool for opening a contact lens package having a bowl, a deck, and at least one tab extending from the deck; the tool comprising:
a top clamshell housing comprising;
a movable jaw connected to a proximate end of the top clamshell housing; and
an opening in the top clamshell housing;
a bottom clamshell housing comprising;
a bowl cavity positioned within the bottom clamshell housing;
a platform surrounding the bowl cavity;
an aperture in the platform sized to accept the at least one tab; and
a fixed jaw connected to the platform and surrounding the aperture; and
a hinge connecting the top clamshell housing with the bottom clamshell housing.

30. The dexterity tool of claim 29 wherein:
the movable jaw extends from a proximate edge of the opening in the top clamshell housing.

31. The dexterity tool of claim 29 wherein:
the tool has a clamping portion that is proximate to the hinge and a clearance portion that is distal to the hinge.

32. The dexterity tool of claim 29 wherein:
the bowl cavity of the bottom clamshell housing is sized to accept the bowl of the contact lens package.

33. The dexterity tool of claim 29 wherein:
the top clamshell housing has an elliptical shape.

34. The dexterity tool of claim 29 wherein:
the opening is aligned with the bowl of the package and the bowl cavity of the bottom housing when the device is in a closed position.

35. The dexterity tool of claim 29 wherein:
when the tool is placed in a closed position the deck of the contact lens package is sandwiched in between the movable jaw and the fixed jaw.

36. A method for using a dexterity tool to open a contact lens package to remove a contact lens, the method comprising:
opening the dexterity tool;
aligning a bowl in the contact lens package with a bowl in the dexterity tool;
closing the dexterity tool until there is enough clamping pressure to hold the contact lens package securely in place;
holding the dexterity tool in a closed position with a first hand while removing a portion of a lid of the contact lens package with a second hand; and
removing the contact lens from the contact lens package.

37. The method of claim 36 further comprising:
opening the dexterity tool; and
removing the contact lens package from the dexterity tool.

38. The method of claim 36 further comprising:
aligning a tab extending from the contact lens package with an aperture placed in the dexterity tool.

39. The method of claim 36 further comprising:
reaching through an opening in the dexterity tool to grasp a tail of the lid on the contact lens package.

40. The method of claim 36 wherein:
the step of holding the dexterity tool in a closed position with a first hand while removing a portion of a lid of the contact lens package with a second hand is performed while holding the dexterity tool in the palm of the user's hand with a thumb on one side of the dexterity tool and fingers on the opposite side of the dexterity tool.
